(19) United States
(12) Patent Application Publication
(10) Pub. No.: US 2023/0141307 A1
(43) Pub. Date: May 11, 2023

(54) RESERVE EQUATED MONTHLY INSTALLMENT ACCOUNT

(71) Applicant: Wells Fargo Bank, N.A., San Francisco, CA (US)

(72) Inventors: Srinivas Rao Gundadi, Hyderabad (IN); Mahendra Reddy Kona, Hyderabad (IN)

(21) Appl. No.: 17/034,781

(22) Filed: Sep. 28, 2020

(51) Int. Cl. G06Q 20/22; G06Q 20/24; G06Q 20/10

(52) U.S. Cl. CPC G06Q 20/227; G06Q 20/24; G06Q 20/102

(57) ABSTRACT

Providing a reserve equated monthly installment (EMI) account to pay an installment payment associated with a debt. Information including a customer financial account including an account balance and information regarding a debt payable in installments including the payment amount and due date are received. When insufficient funds exist to pay the installment payment amount by the due date, a reserve EMI account is opened, and loaned funds are used to pay the installment payment amount.

### BACKGROUND

Individuals and/or companies make various monthly or otherwise periodic payments via a financial account to pay down a debt. A penalty is often applied when the individual and/or company misses one of the payments. It is up to the individual and/or company to make sure they have enough funds in a financial account to pay the amount due. Financial institutions who hold the financial account may not take assertive action to supplement a payment for a customer that cannot cover a periodic payment. For example, financial institutions may allow payments from customer accounts when a customer runs out of funds, but then the customer may be assessed an overdraft fee.

### SUMMARY

Embodiments of the disclosure are directed to a system and method of providing a reserve equated monthly installment (EMI) account when insufficient funds exist in a customer financial account to pay a debt at a due date.

In a first embodiment, a method is implemented on an electronic computing device that provides a reserve EMI account. The method includes receiving information regarding a customer financial account, including an account balance; receiving information regarding a debt payable in installments, including an installment payment amount and a due date for each of the installments; determining, based on the installment payment amount, whether sufficient funds exist in the financial account to pay the installment payment amount by the due date; and when insufficient funds exist in the financial account to pay the installment payment amount: performing a benefits analysis to determine whether to open a reserve EMI; determining, based on the benefits analysis, to open the reserve EMI account; and transmitting a payment from the reserve EMI account to pay an amount of the installment payment amount.

In another embodiment, a system includes an electronic computing device including a processor; and a system memory, the system memory including instructions, which, when executed by the processor, cause the electronic computing device to perform the following steps: receive information regarding a customer financial account, including an account balance; receive information regarding a debt payable in installments, including an installment payment amount and a due date for each of the installments; determine, based on the installment payment amount, whether sufficient funds exist in the financial account to pay the installment payment amount by the due date; and when insufficient funds exist in the financial account to pay the installment payment amount: perform a benefits analysis to determine whether to open a reserve EMI account; determine, based on the benefits analysis, to open the reserve EMI account; and transmit a payment from the reserve EMI account to the financial account to pay the installment payment amount.

In yet another embodiment, a method is implemented on an electronic computing device to provide a reserve EMI account. The method includes: receiving information regarding a customer financial account, including an account balance; receiving information regarding a debt payable in installments, including an installment payment amount and a due date for each of the installments; determining, based on the installment payment amount, whether sufficient funds exist in the financial account to pay the installment payment amount by the due date; when insufficient funds exist in the financial account to pay the installment payment amount by the due date: transmitting an alert of insufficient funds to a customer; receiving, from the customer, consent to open the reserve EMI account; performing a benefits analysis to determine whether to open a reserve EMI account; determining, based on the benefits analysis, to open the reserve EMI account, and transmitting a payment from the reserve EMI account to the financial account to pay the installment payment amount; and when there are sufficient funds to pay the installment payment amount by the due date, transmitting the payment from the customer financial account to pay the installment payment amount.

The details of one or more techniques are set forth in the accompanying drawings and the description below. Other features, objects, and advantages of these techniques will be apparent from the description, drawings, and claims.

### DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example environment for implementing a reserve EMI account.

FIG. 2 illustrates an example block diagram of a server of FIG. 1.

FIG. 3 illustrates an example method used to determine whether to open a reserve EMI account.

FIG. 4 illustrates an example method when the reserve EMI determination process is initiated.

FIG. 5 illustrates an example method of performing a cost/benefit analysis.

FIG. 6 illustrates an example method of determining tangible and intangible costs associated with opening a reserve EMI account.

FIG. 7 illustrates an example user interface associated with the methods described herein.

FIG. 8 illustrates example components of a computing device of a financial institution in the environment of FIG. 1.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The systems and methods herein are directed towards providing a reserve equated monthly installment (EMI) account to customers who are at risk of missing an installment payment. The method further includes determining when fees and/or interest associated with opening an EMI account is more beneficial to the customer than paying fees and/or interest (or other penalties) associated with missing the installment payment associated with the debt.

Customers often have debt that is payable each month (or in other periods). A customer may be an individual or a business. The debt may be a fixed amount due each period, or may be an amount that changes each period. The debt is also associated with a due date, and if the customer does not pay the required amount by the due date, they may incur various penalties. Opening a reserve EMI account can mitigate the penalties the customer may incur if they miss a payment or pay late.

The customers make the various monthly or otherwise periodic payments, herein referred to as an installment payment, via a financial account associated with a financial institution. A penalty is often applied when the customer misses a periodic payment or pays the periodic payment after the due date. The penalty may include a fee or increased interest on a loan and is often disproportionate to the harm caused by missing the payment. A late payment penalty may also lower the credit score of the customer. Missing a payment can result in a severe impact to the customer.

The financial institution, such as a bank, is in a position to aid customers in creating a reserve EMI account. Financial institution systems may already organize a customer's payment information, schedule automatic payments, and send reminders to customers. These financial institution systems protect customers from making organizational mistakes or forgetting to make a payment when they have the funds to do so.

The reserve EMI account as described herein is a loan that may be automatically opened on behalf of the customer when it is beneficial to the customer to borrow money from the financial institution to pay the installment payment rather than accept a penalty for a missed payment.

To prevent a customer, who does not have sufficient funds to make an installment payment, from being unduly harmed by a penalty, the customer's financial account holder may take automatic action to aid the customer. The customer's financial institution may automatically loan the customer the amount needed and make the payment for the customer. The customer's financial institution may weigh the potential harm to the customer against the monetary amount needed as the financial institution makes a determination to automatically loan the customer the funds needed to make the installment payment.

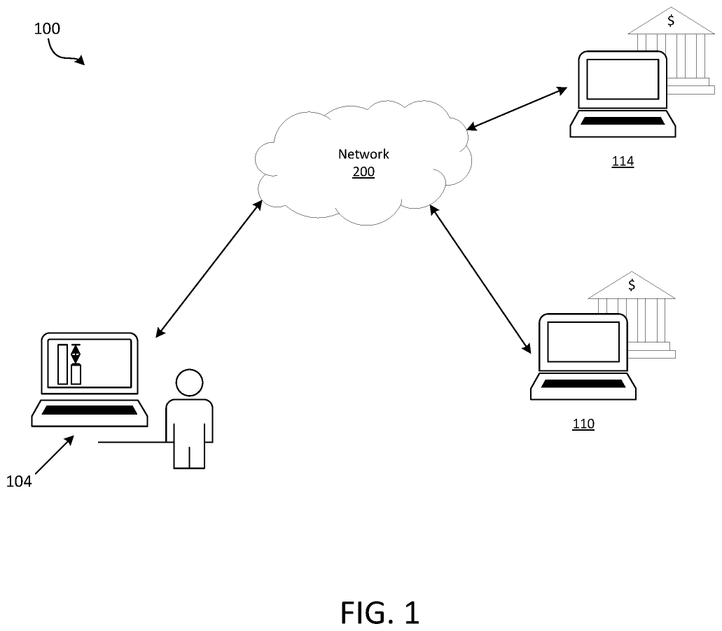

FIG. 1 illustrates an example environment 100 for implementing a reserve EMI account. The environment 100 includes a network 200 connecting a customer computing device 104 with servers 110, 114. In an example, server 110 is associated with a first financial institution and server 114 is associated with a second financial institution. In a further embodiment, more servers may be utilized.

In an embodiment, where a reserve EMI is to be opened, a customer financial account has an insufficient amount to pay an installment payment amount. When an insufficient amount exists in the customer financial account to pay the installment payment amount, a network 200 which connects a financial institution server 110 determines the risk/benefits associated with opening a reserve EMI account for the customer.

If it is determined that opening a reserve EMI account is beneficial to the customer, the financial institution server 110 opens the reserve EMI account and loans an amount to the customer. The loaned amount is sufficient to allow the customer to pay the installment amount in full. In a first example, the loaned amount is a partial amount of the total installment amount. In another example, the loaned amount is the full amount of the total installment payment amount. As described in more detail below, opening a reserve EMI account is associated with a fee or interest amount.

The network 200 can also communicate with a financial institution server 114 associated with the installment payment amount to determine how much is due each month (or period) and the due date. The network 200 may also receive other details needed to make the installment payment amount. In another embodiment, the financial institution server 110 receives the information from a customer, who inputs the information via a user interface of a computing device. In still yet another embodiment, the information may be scanned and extracted from a scanned image of a statement. A software application on an electronic computing device, typically a server computer, can be used to extract information, such as the installment payment amount and the due date. In some implementations, the software application can use artificial intelligence (AI). AI can be helpful in identifying the pertinent information on the statement, using an identified format to know where to look for specific information on the statement and to automatically extract the pertinent information from the scanned image of the statement.

The examples as described herein refer to an installment payment; however, more than one installment payment may be considered. For example, a customer may have two different installment payments due on the same day, and if the customer has insufficient funds, then the reserve EMI account is opened to cover both installment payments. Still further, if a customer already has a reserve EMI account opened, additional funds may be added as needed.

The financial institution server 110 can provide systems and methods that improve the computing efficiencies of existing systems. Efficiency relates to the resources required to open a reserve EMI account and loan a customer a predetermined amount to pay an installment payment amount before the due date. Automating the process of opening a reserve EMI account can result in a faster process, as well as requiring less communication between computing devices. Further, new methods and operating components within a financial institution are provided that increase the functionality of the financial institution server, as described herein.

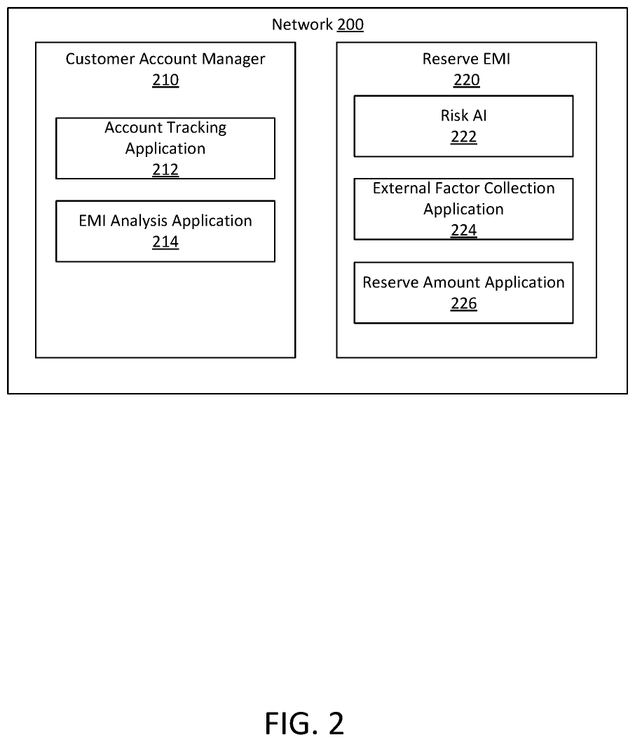

FIG. 2 illustrates an example block diagram of a network 200 utilized to determine when to open a reserve EMI account for a customer. The network 200 includes a customer account manager application 210 and a reserve EMI application 220. The customer account manager application 210 manages a customer's financial accounts at the financial institution. The customer account manager application 210 also manages and processes transactions that are paid out by the financial account, for example, the installment payment.

The customer account manager application 210 includes an account tracking application 212 and a reserve EMI analysis application 214. The account tracking application 212 collects information about the customer's financial account that is useful in determining when to implement a reserve EMI account. For example, the account tracking application 212 may collect paycheck amounts and frequency, which is useful in determining the likelihood of a customer's ability to pay back the reserve EMI loaned amount.

The reserve EMI analysis application 214 tracks the various installment payments a customer is paying. For example, a customer may have utility bills, a mortgage payment, and credit card bills. Other types of installment payments may also include student loans, car payments, and other payments made every month. The various installment payments may be a fixed amount due each month, or may be a different amount each period, and/or have varying frequencies (such as quarterly or yearly). The installment payments may also have different penalties associated with missed or late payments. The penalty details may be received from the holder of the debt 114 via the network 200. Alternatively, the customer may input the information via a user interface of a computing device. In still yet another embodiment, the information may be scanned and extracted from a scanned image of a statement. As explained above, a software application on an electronic computing device, typically a server computer, can be used to extract information from a statement, using, for example, AI.

The computing system and the reserve EMI analysis application 214 provides an improvement in the way traditional banking systems work. The computing system is more efficient and faster than traditional systems. Efficiency is increased when the system is able to communicating issues, such as a possible payment shortfall to customers and/or addressing the issue automatically by opening a loan. Further, the system is able to more effectively mitigate potential overdraft and/or non-payment problems associated with missing an installment payment.

The reserve EMI analysis application 214 tracks variables associated with installment payments so that they may be considered by the financial institution network 200. As described in more detail below, the reserve EMI analysis application 214 may send an alert when the customer is in danger of missing an installment payment. The alert may include the amount needed, the due date, and a penalty associated with missing the payment.

The reserve EMI application 220 includes a risk AI application 222, an external factor collection application 224, and a reserve amount application 226. The reserve EMI application 220 is configured to make a determination as to whether to activate and pay a customer's installment payment. For example, the reserve EMI application 220 automatically loans the customer funds to make an installment payment(s) on time when the customer has given preauthorization to do so. Alternatively, a reserve EMI application 220 may be configured to request authorization from a customer before opening a reserve EMI account to make an installment payment.

Still further, the reserve EMI application 220 may automatically open a reserve EMI account when the customer's financial account drops below a threshold amount. The customer may determine the threshold amount. Alternatively, the threshold amount may be determined by an artificial intelligence (AI) software application that uses the payment history and financial account history of the customer to determine a threshold amount that is useful in predicting when the customer is at risk of missing an installment payment.

The risk AI application 222 evaluates whether to pay an installment payment for a customer. The risk AI application 222 may weigh multiple factors in such a determination. In one example, the risk AI application 222 may weigh the potential damage to the customer for missing an installment payment versus the amount needed to make the installment payment. If the amount needed is lower than the potential damage of missing a payment, the risk AI application 222 may determine to loan the customer the amount needed and pay the installment payment amount.

In another example, the risk AI application 222 may evaluate the probability that the customer can pay off a loan from an EMI account opened for the customer. The risk AI application 222 may take into account various factors that were collected from the customer such as the work history of the customer, the customer's income, and the credit history of the customer. Other factors include whether or not the customer has missed a payment before, how much debt the customer has, and other similar factors that may affect the customer's ability to pay back a loan.

The external factor collection application 224 collects information from outside the customer's financial account that may be relevant to the risk AI application 222 in determining whether to loan funds to the customer. For example, the potential damage from missing a professional license payment may be large because it could reduce the customer's income. External factors may be used to determine the customer's future income, which could be used to evaluate the customer's potential damage and ability to repay a loan. For example, the jobs market for the customer's occupation along with the customer's location, age, and experience may all be factored into the customer's future income.

A threshold amount is an amount that will be transferred to a customer financial account and is the loan amount associated with the reserve EMI account determined by the reserve amount application 226. The threshold amount may change based on the evaluation by the risk AI application 222. For example, the threshold amount may increase for installment payments that, if missed, can potentially damage the customer's income. In an alternative embodiment, the threshold amount may decrease for installment payments that, when missed, do not significantly damage the customer. For example, missing a payment for a video rental subscription might not significantly damage a customer and the threshold amount would be lower in such cases.

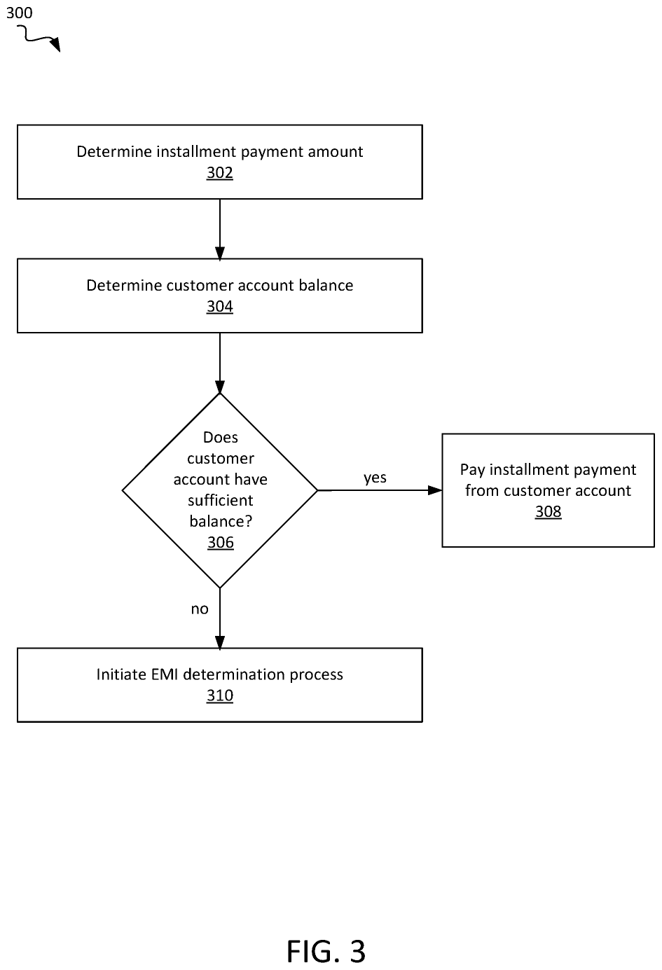

FIG. 3 illustrates an example embodiment of a method 300 used to determine whether to open a reserve EMI account according to embodiments described herein. The method 300 includes steps to determine whether or not a reserve EMI account needs to be opened for the customer.

At step 302, an installment payment amount is determined. An installment payment amount is an amount associated with one or more loans that are paid monthly (or periodically) by the customer. Types of loans include, for example, mortgages, car payments, credit card payments, student loans, and utility payments. These types of loans may be associated with a fixed payment amount, or may have payment amounts that differ each month. These loans are also associated with a due date, and if the payment is not received by the specified date, the customer may be impacted.

At step 304, a customer account balance is determined. The customer account balance determination may be specific to a single customer financial account, or may be a determination across a plurality of customer financial accounts held by the financial institution. In a first example, the customer financial account balance determination is determined with reference to the account that is used to previously pay the installment payment. In another example, the customer financial account balance determination is determined based on any account held by the customer.

At step 306, it is determined whether the customer account has a balance sufficient to pay the installment payment amount. As explained above, the determination may be specific to a single customer account, or may be determined based on an overall balance of a plurality of customer accounts.

If the customer account has a balance sufficient to pay the installment payment amount, the method 300 moves to step 308 and the installment payment is processed to be paid from the customer account.

If the customer account does not have a balance sufficient to pay the installment payment, then the method 300 moves to step 310. At step 310, the reserve EMI determination process is initiated. This process is explained in more detail below.

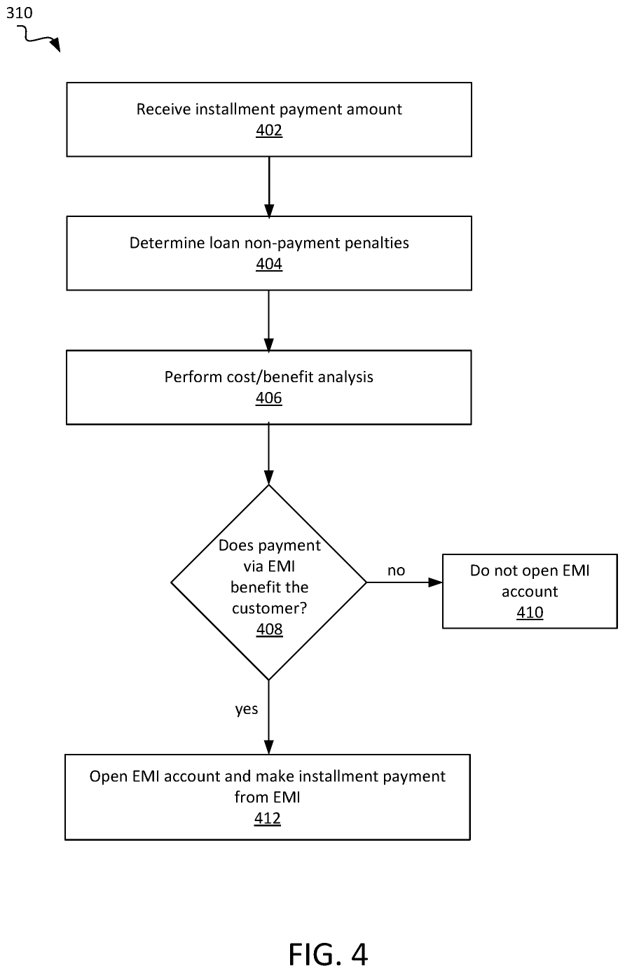

FIG. 4 illustrates an example method of performing step 310, wherein the reserve EMI determination process is initiated.

At step 402, the installment payment amount is received. As explained above, this amount may be a fixed payment amount, or may be different each month. In a first embodiment, the installment payment amount is associated with a single loan, while in an alternative embodiment, the installment payment amount may be an amount associated with a plurality of loans, for example, if a plurality of loans are due on the same day, or due before a customer is paid.

At step 404, loan nonpayment penalties are determined. For example, if a monthly payment is missed or paid late, the customer may be responsible for paying a late payment fee and/or additional interest payments. In a further example, if a monthly payment is missed or paid late, the customer may receive negative external factors. Such negative external factors include, but are not limited to, a lower credit score, a lapse in membership, or other similar factors.

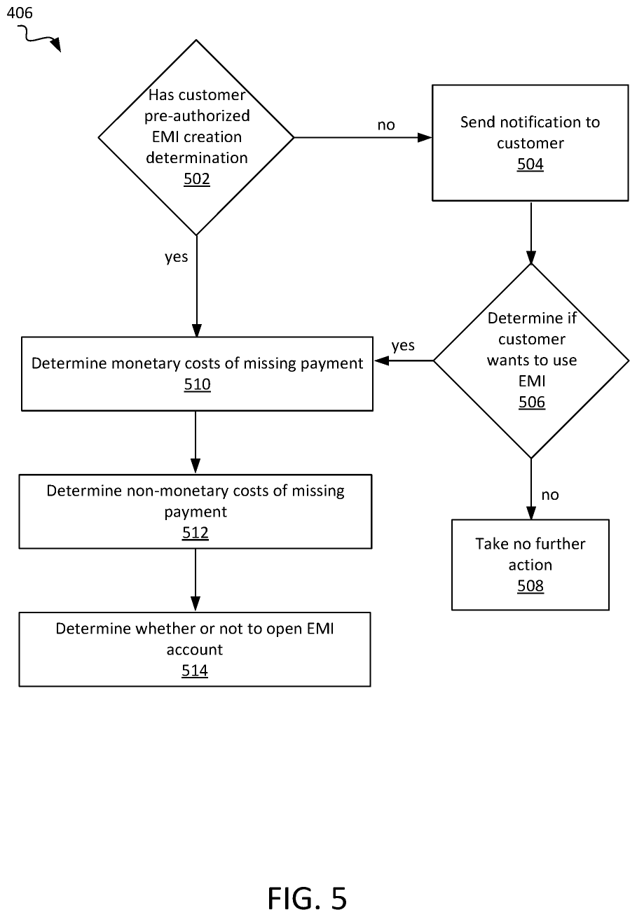

At step 406, a cost/benefit analysis is performed. Step 406 includes determining whether or not it is beneficial to the customer to open a reserve EMI account and use those funds to pay the loan amount. Step 406 is explained in more detail at FIG. 5.

At step 408, it is determined whether or not payment via a reserve EMI account would benefit the customer. If paying via a reserve EMI account would not benefit the customer, then the method moves to step 410, wherein a reserve EMI account is not opened.

If paying via a reserve EMI account is a benefit for the customer, then the method moves to step 412. At step 412, a reserve EMI account is opened for the customer and the installment payment is made from funds transferred from the reserve EMI account to the customer financial account. The reserve EMI account is a loan account, and the customer becomes responsible for paying back the loaned amount.

FIG. 5 illustrates an example embodiment of the method of step 406. The figure illustrates a more detailed method of performing the cost/benefit analysis.

At step 502, a system, for example, the reserve EMI application 220, determines whether or not the customer has preauthorized a reserve EMI account creation determination procedure. For example, when a customer initially signs up to make loan payments, they may be presented with the option to have the reserve EMI determination process automatically start if they ever have insufficient funds to pay the installment payment amount.

If the customer has not preauthorized the reserve EMI determination process, then the method of step 406 moves to step 504, where a notification is sent to the customer. A notification sent to the customer indicates to the customer that they have insufficient funds to cover at least a portion of the installment payment amount.

At step 506, it is determined if the customer wants to use a reserve EMI determination process. For example, a customer may be presented with an option to opt-in or opt-out via a user interface of an application associated with the financial institution. In another example, a customer may be provided a link embedded in an email or text message, where the link allows a user to opt-in or opt-out of the reserve EMI determination process. If the customer does not want to use a reserve EMI determination process, then the method of step 406 moves to step 508, where no further action is taken.

If the customer wants to use the reserve EMI determination process, then the method of step 406 moves to step 510, where the monetary costs of missing a payment are determined. Monetary costs may include things such as a late payment fee or requiring interest payments on the late or unpaid amount. The monetary costs are determined by the company holding the loan and received by the financial institution.

At step 512, the non-monetary costs of missing a payment are determined. Non-monetary costs may include things such as a credit score point deduction, the possibility that the loan is sent to collections, a lapse in a professional membership, a lapse in insurance coverage, or other similar factors.

Determining the non-monetary and monetary costs of missing a payment or making a late payment may be specific to the individual, or may be dependent on other factors such as the industry associated with the loan, the credit score of the individual, the customer's salary, or other similar factors.

At step 514, it is determined whether or not to open a reserve EMI account to pay the installment payment amount. A reserve EMI account may be used to pay the installment payment amount when the benefits to the customer outweigh the costs. For example, the benefits to the customer may outweigh the costs when the fees and/or interest associated with opening the reserve EMI account are less than the late fees associated with missing an installment payment. In another example, the benefits outweigh the costs if missing an installment payment could cause a lapse in a customer's professional license, or ability to work.

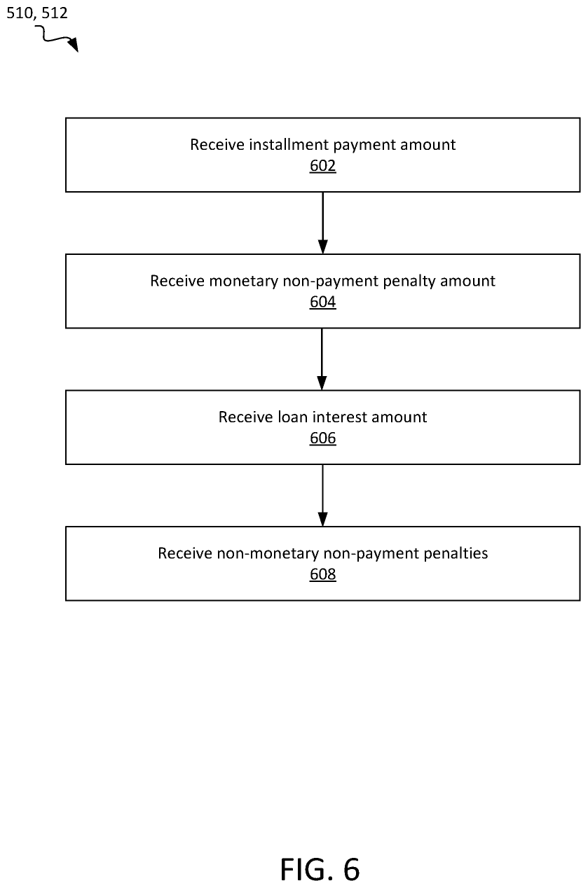

FIG. 6 illustrates an example method of performing steps 510, 512 to determine the monetary and non-monetary costs associated with performing the cost/benefits analysis.

At step 602, the installment payment amount is received. This amount can include the minimum payment required, or the total amount due. For example, if the debt is associated with a credit card, both the minimum payment due and the account balance are received. A determination, based on both the payment history of the customer and the customer account balance, is used to determine whether the minimum payment is to be paid, or the full account balance is to be paid. Further, the amount desired to be paid may be received by the customer.

At step 604, the monetary non-payment penalty amounts are received. The monetary non-payment penalties may include a one-time late payment fee or non-payment fee.

At step 608, loan interest amounts are received. The loan interest amount is received and then is used to calculate a dollar amount based on the installment payment amount. If the customer can only pay a minimum amount due, then the interest is calculated accordingly.

At step 608, non-monetary non-payment penalties are received. Non-monetary penalties include things such as a credit score point deduction, the possibility that the loan is sent to collections, a lapse in a professional membership, a lapse in insurance coverage, or other similar penalties. The potential damage, for instance, of a business customer not making an insurance payment would be high because the missed payment could impact the business's revenue.

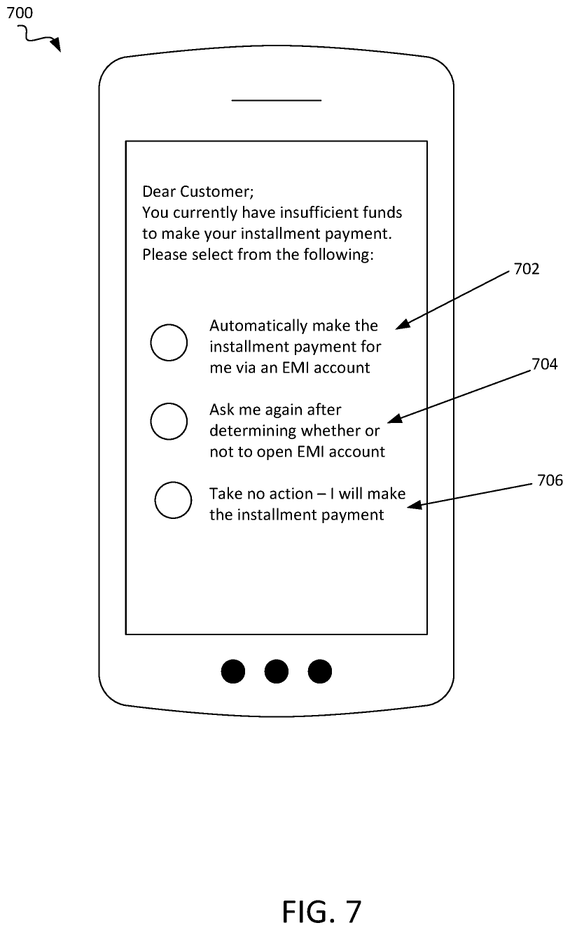

FIG. 7 illustrates an example user interface 700 of sending a customer a notification. For example, as shown, a customer is notified that they have insufficient funds in his/her financial account to pay the installment payment amount. The user interface 700 provides three options for the customer to respond.

A first response 702 may be to automatically make the installment payment for the customer via a reserve EMI account. A second response 704 may be to notify the customer again after determining whether to open the reserve EMI account. This may include presenting the costs and benefits associated with opening the reserve EMI account to the customer before the customer makes their decision. A third response 706 may include to take no action. The selection takes no further action on behalf of the customer.

A notification may also be sent to a customer who has preauthorized the opening of a reserve EMI account, and it has been determined that a reserve EMI account should be opened.

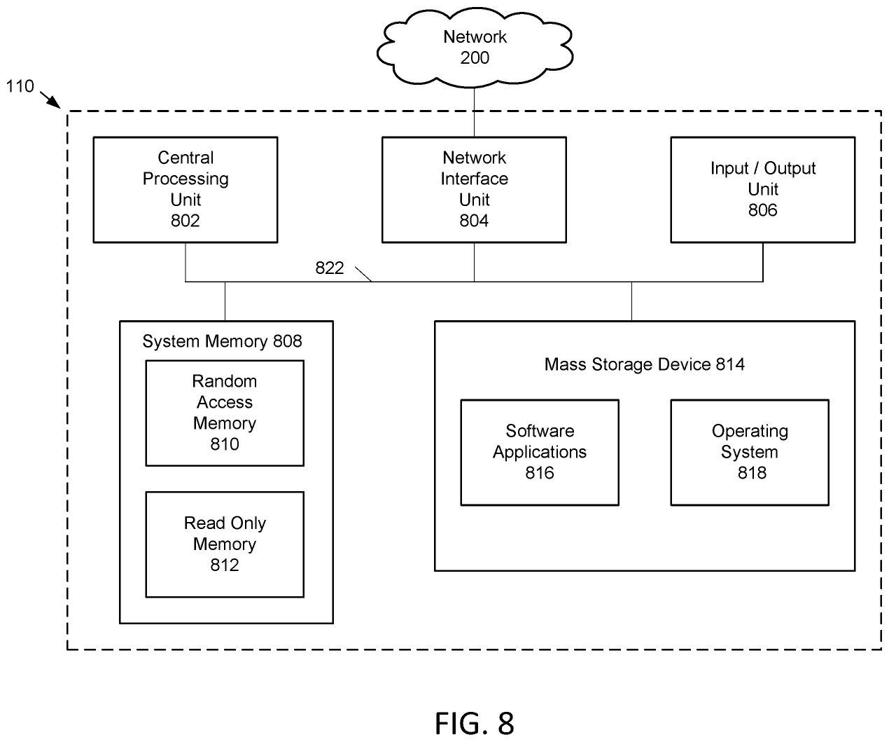

As illustrated in FIG. 8, example physical components of the financial institution server device 110 are shown. Other computing devices (e.g., the customer computing device 104 and the financial institution server computing device 114) can be configured in a similar manner.

The financial institution server device 110 includes at least one central processing unit (“CPU”) 802, also referred to as a processor, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the financial institution server device 110, such as during startup, is stored in the ROM 812. The financial institution server device 110 further includes a mass storage device 814. The mass storage device 814 is able to store software instructions and data.

The mass storage device 814 is connected to the CPU 802 through a mass storage controller (not shown) connected to the system bus 822. The mass storage device 814 and its associated computing device-readable data storage media provide non-volatile, non-transitory storage for the financial institution server device 110. Although the description of computing device-readable data storage media contained herein refers to a mass storage device, such as a hard disk or solid state disk, it should be appreciated by those skilled in the art that computing device-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program applications or other data. Example types of computer-readable data storage media include, but are not limited to, random access memory (“RAM”), read-only memory (“ROM”), erasable programmable read-only memory (“EPROM”), electrically erasable programmable read-only memory (“EEPROM”), flash memory or other solid state memory technology, compact disc read-only memory (“CD-ROMs”), digital versatile discs (“DVDs”), other optical storage media, magnetic cassettes, magnetic tape, magnetic disk storage or other magnetic storage devices, or any other medium which can be used to store the desired information and which can be accessed by the financial institution server device 110.

According to various embodiments, the financial institution server device 110 may operate in a networked environment using logical connections to remote network devices through the network 200, such as the Internet, or another type of network. The financial institution server device 110 may connect to the network 200 through a network interface unit 804 connected to the system bus 822. It should be appreciated that the network interface unit 804 may also be utilized to connect to other types of networks and remote computing systems. The financial institution server device 110 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the financial institution server device 110 can store software instructions and data. The software instructions include an operating system 818 suitable for controlling the operation of the financial institution server device 110. The mass storage device 814 and/or the RAM 810 also store software instructions and software applications 816, that when executed by the CPU 802, cause the financial institution server device 110 to provide the functionality discussed in this document. For example, the mass storage device 814 and/or the RAM 810 can store software instructions that, when executed by the CPU 802, cause the financial institution server device 110 to route requests between existing application code and new application code.

The computing devices described herein result in the practical application of addressing shortages in payment amounts more efficiently. The computing devices are programmed to proactively identify such shortages, which results in the computing devices efficiently communicating such issues to customers and/or possibly addressing the issue automatically. This results in a system that functions independently and more quickly.

FIGS. 1-8 illustrate example systems and methods used to determine when a reserve EMI account should be opened to loan a customer an amount of money to pay an installment payment associated with a debt before a due date. As described, the method includes performing a cost/benefit analysis to ensure the opening of a reserve EMI account is beneficial to the customer. The amount of the reserve EMI account is at least the amount of the installment payment amount so the customer is able to pay without incurring any penalties associated with missing a payment or paying late.

Embodiments of the present disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure in any way. The embodiments, examples, and details provided in this application are considered sufficient to convey possession and enable others to make and use the disclosed embodiments. The disclosure should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the disclosure and the general inventive concept embodied in this application that do not depart from the broader scope.

1. A method implemented on an electronic computing device of a financial institution for providing a reserve equated monthly installment (EMI) account to a customer, the method comprising:
receiving information regarding a customer financial account, including an account balance;
receiving information regarding a debt payable in installments, including an installment payment amount and a due date for each of the installments;
determining, based on the installment payment amount, whether sufficient funds exist in the financial account to pay the installment payment amount by the due date; and
when insufficient funds exist in the financial account to pay the installment payment amount:
performing a benefits analysis to determine whether to open a reserve EMI account by comparing a penalty associated with missing the installment payment with a fee associated with opening the reserve EMI account;
performing a risk analysis by determining a risk associated with the customer's ability to repay funds deposited into the EMI account by the financial institution, including a risk of a reduction in the customer's future income;
determining, based on the benefits analysis and the risk analysis, to open the reserve EMI account on behalf of the customer when the fee is less than the penalty and the risk is below a threshold level;
upon determining to open the reserve EMI account, automatically opening the reserve EMI account with a loan payment amount that is sufficient to allow the customer to pay the installment payment amount; and
transmitting the loan payment amount from the reserve EMI account to the financial account to pay the installment payment amount.

2. (canceled)

3. The method of claim 1, wherein the penalty associated with missing the installment payment is at least one of a late fee or an interest-accruing payment.

4. The method of claim 1, wherein performing the benefits analysis comprises considering external risk factors selected from at least one of: a work history of the customer, an income of the customer, and a credit history of the customer.

5. The method of claim 1, wherein determining whether sufficient funds exist includes determining whether there are insufficient funds to pay at least a portion of the installment payment amount.

6. The method of claim 1, wherein receiving the account balance includes receiving a balance from at least one customer financial account.

7. The method of claim 1, wherein opening the reserve EMI account comprises loaning a predetermined amount to the customer.

8. The method of claim 7, wherein the predetermined amount includes the installment payment amount and a fee associated with opening the reserve EMI account.

9. The method of claim 1, wherein determining to open the reserve EMI account further includes transmitting an alert of insufficient funds to the customer and obtaining a consent of the customer to open the reserve EMI account.

10. The method of claim 1, further comprising transmitting a payment receipt to the customer confirming that the loan payment amount was made from the reserve EMI account.

11. The method of claim 1, wherein the benefits analysis is performed by an artificial intelligence (AI) software application.

12. An electronic computing device of a financial institution comprising:
a processor; and
a system memory, the system memory including instructions, which, when executed by the processor, cause the electronic computing device to:
receive information regarding a customer financial account associated with a customer, including an account balance;
receive information regarding a debt payable in installments, including an installment payment amount and a due date for each of the installments;
determine, based on the installment payment amount, whether sufficient funds exist in the financial account to pay the installment payment amount by the due date; and
when insufficient funds exist in the financial account to pay the installment payment amount:
perform a benefits analysis to determine whether to open a reserve EMI account by comparing a penalty associated with missing an installment payment with a fee associated with opening the reserve EMI account;
perform a risk analysis by determining a risk associated with the customer's ability to repay funds deposited into the EMI account by the financial institution, including a risk of a reduction in the customer's future income;
determine, based on the benefits analysis and the risk analysis, to automatically open the reserve EMI account on behalf of the customer when the fee is less than the penalty and the risk is below a threshold level;
upon determining to open the reserve EMI, automatically opening the reserve EMI account with a loan payment amount that is sufficient to allow the customer to pay installment payment amount; and
transmit the loan payment amount from the reserve EMI account to the financial account to pay the installment payment amount.

13. The electronic computing device of claim 12, wherein the benefits analysis is performed by an artificial intelligence (AI) software application.

14. (canceled)

15. The electronic computing device of claim 12, wherein the penalty associated with missing the installment payment is at least one of a late fee or an interest-accruing payment.

16. The electronic computing device of claim 12, wherein performing the benefits analysis comprises considering external risk factors selected from at least one of: a work history of the customer, an income of the customer, and a credit history of the customer.

17. The electronic computing device of claim 12, wherein prior to opening the reserve EMI account, a notification of insufficient funds is transmitted to the customer, and a consent of the customer to open the reserve EMI account is obtained.

18. The electronic computing device of claim 12, wherein after the loan payment amount is transmitted, a payment receipt is sent to the customer confirming that the installment payment was made via the reserve EMI account.

19. A method implemented on an electronic computing device of a financial institution for providing a reserve equated monthly installment (EMI) account to a customer comprising:
receiving information regarding a customer financial account, including an account balance;
receiving information regarding a debt payable in installments, including an installment payment amount and a due date for each of the installments;
determining, based on the installment payment amount, whether sufficient funds exist in the financial account to pay the installment payment amount by the due date;
when insufficient funds exist in the financial account to pay the installment payment amount by the due date:
transmitting an alert of insufficient funds to a customer;
receiving, from the customer, consent to open the reserve EMI account;
performing a benefits analysis to determine whether to open a reserve EMI account by comparing a penalty associated with missing the installment payment with a fee associated with opening the reserve EMI account;
performing a risk analysis by determining a risk associated with the customer's ability to repay funds deposited into the reserve EMI account by the financial institution, including a risk of a reduction in the customer's future income;
determining, based on the benefits analysis and the risk analysis, to open the reserve EMI account on behalf of the customer when the fee is less than the penalty and the risk is below a threshold level, and transmitting a payment from the reserve EMI account to the financial account to pay the installment payment amount;
upon determining to open the reserve EMI account, automatically opening the reserve EMI account with a loan payment amount that is sufficient to allow the customer to pay the installment payment amount; and
when there are sufficient funds in the reserve EMI account to pay the installment payment amount by the due date, transmitting the loan payment amount from the customer financial account to pay the installment payment.

20. The method of claim 19, wherein the benefits analysis is performed by an artificial intelligence (AI) software application.

21. The method of claim 1, further comprising determining that the customer has preauthorized creation of the reserve EMI account.
